(19) United States
(12) Patent Application Publication
(10) Pub. No.: US 2026/0155784 A1
(43) Pub. Date: Jun. 4, 2026

(54) Method And Device For Characterizing A Photovoltaic Module

(71) Applicant: Electricite de France, Paris (FR)

(72) Inventors: Christine Abdel Nour, Saclay (FR); Julien Dupuis, Bois-Le-Roi (FR)

(73) Assignee: Electricite de France, Paris (FR)

(21) Appl. No.: 19/402,729

(22) Filed: Nov. 26, 2025

(30) Foreign Application Priority Data
Nov. 29, 2024 (FR) 2413238

(51) Int. Cl. H02S 50/15; G01J 3/02; G01J 3/10; G01J 3/12; G01J 3/26

(52) U.S. Cl. CPC H02S 50/15; G01J 3/0224; G01J 3/10; G01J 3/26; G01J 2003/1291

(57) ABSTRACT

The present disclosure concerns a method for characterizing a photovoltaic module, by means of a device for characterizing a photovoltaic module, the characterizing device comprising a light source so as to illuminate an object, a spectrometer comprising an optical acquisition axis and a polarizing filter comprising a polarization axis and arranged in front of the spectrometer, the light reflected by the object passing through the polarizing filter to be subsequently captured by the spectrometer, and a processing unit.

### TECHNICAL FIELD

The invention concerns a method for characterizing a photovoltaic module, to evaluate its performance quantitatively, or to identify possible defects of the module in a non-destructive manner. In particular, the invention aims to evaluate the degradation of the anti-reflective coating of a photovoltaic module.

### STATE OF THE ART

The reflection of the surface of a photovoltaic module must be as low as possible to maximize light transmission in the module and ensure photovoltaic conversion. For this purpose, the front surface of photovoltaic modules is almost always equipped with an anti-reflective coating (ARC).

This anti-reflective coating is a thin coating layer applied to the glass of photovoltaic modules to minimize the reflection of incident light. This reduction increases the amount of light captured by the module, thus increasing its overall efficiency.

The working principle of the anti-reflective coating is based on the phenomenon of reflected radiation interference between the glass and the anti-reflective coating. In the vast majority of cases, the modules have a layer of glass to ensure their mechanical strength and rigidity. The anti-reflective coating is mainly deposited on top and the ideal thickness and refractive index are calculated so as to guarantee destructive interference between the ray transmitted by the anti-reflective coating and reflected by the glass and a second ray transmitted by the anti-reflective coating. Reflections between the other layers of the module are considered negligible. The idea is that, for a given wavelength, the wave transmitted by the anti-reflective coating and reflected by the glass finds a wave of opposite phase at the boundary between the air and the anti-reflective coating provided that the thickness d is equal to a quarter of the wavelength, making an optical path of half a phase and thus arriving with an opposite phase at the interface. The “destroyed” part is absorbed by the material and helps to increase the panel's efficiency. The ideal refractive index is given by n=\sqrt{n_{glass} nₐᵢᵣ}. Typically, a module without an anti-reflective coating reflects 4% of the useful light received and a module with an ARC reflects 1%.

This coating measures only a few tens of nanometers and is subjected to external conditions during the life of the photovoltaic module. Depending on the location, its lifespan can be very short (abrasion related to sandstorms for example) or equivalent to the lifespan of photovoltaic modules (more than 30 years).

To evaluate the performance of a photovoltaic module, it is necessary to estimate the degradation of this anti-reflective coating. Indeed, complete deterioration of this anti-reflective coating introduces a loss of the nominal power of the module. The causes of this damage depend on several factors such as the climatic conditions of the location, cleaning and the technology of the coating itself. For example, cleaning, robotic or otherwise, solar modules in a plant can damage the ARC if done aggressively.

There is a need to quantify the resistance of the anti-reflective coatings to cleaning methods. This study becomes particularly relevant in desert areas where sandstorms make the issue of cleaning very important.

Quantifying and analyzing the causes of degradation of the layer of anti-reflective coating is not easy to do on site, as it is very difficult to separate the power loss generated by the damage of the anti-reflective coating from other causes of degradation.

In addition, abrasion of the anti-reflective coating can occur physically, i.e. it can be scratched, but without affecting the total light transmission or the performance of the module. It is therefore necessary to have a means of testing its composition or its reflectivity to identify the mechanisms of aging and if possible deterioration.

One problem is that these tests are usually conducted in a laboratory on the scale of the photovoltaic cell and require a sample of the module to be taken, which destroys the module.

### GENERAL DISCLOSURE

An object of the present disclosure is to characterize a photovoltaic module by characterizing its anti-reflective coating in a non-destructive manner.

To this end, according to one aspect of the present disclosure, a method of characterizing a photovoltaic module is proposed, by means of a device for characterizing a photovoltaic module, the characterizing device comprising a light source so as to illuminate an object, a spectrometer comprising an optical acquisition axis and a polarizing filter comprising a polarization axis and arranged in front of the spectrometer, the light reflected by the object passing through the polarizing filter to be subsequently captured by the spectrometer, and a processing unit, the device comprising
a first configuration in which the optical axis of the polarizing filter forms a zero angle with the optical axis of the spectrometer,
a second configuration in which the optical axis of the polarizing filter is perpendicular to the optical axis of the spectrometer,
the method comprising the following steps implemented by the processing unit:
a) acquisition, in the first configuration and in the second configuration respectively, of an intensity reflected by a photovoltaic module illuminated by the light source and measured by the spectrometer;
b) acquisition, in the first configuration and in the second configuration respectively, of an intensity reflected by a reference reflector and measured by the spectrometer;
c) calculation by means of a relationship between the intensities acquired in each configuration of a specular part of the intensity diffused by the photovoltaic module and a specular part of the intensity diffused by the reference reflector;
d) calculation using a relationship between the specular part of the intensity diffused by the photovoltaic module, the specular part of the intensity diffused by the reference reflector, and a reference spectral reflectivity of the reference reflector of a spectral reflectivity of the photovoltaic module, the spectral reflectivity of the photovoltaic module being characteristic of a wear state of the photovoltaic module.

The invention is advantageously supplemented by the following characteristics, taken alone or in any of their technically possible combinations:
In step d) the spectral reflectivity of the photovoltaic module is obtained by the product between the ratio between the specular part of the intensity diffused by the photovoltaic module and the intensity diffused by the reference reflector and the spectral reflectivity of the reference reflector.
The light source comprises a non-polarized main source at infinity and an upstream polarizing filter configured to polarize the main source (S1), the light source illuminating the photovoltaic module and the reference reflector being polarized, in step c) the specular part I_{s module} of the intensity diffused by the photovoltaic module is obtained by I_{s module}=I₂−I₁ and the specular part I_{s ref} diffused by the reference reflector is obtained by means of the relation I_{s ref}=I₄−I₃, I₁ and I₃ being the intensities acquired in the first configuration, I₂ and I₄ being the intensities acquired in the second configuration.
The light source comprises a non-polarized main source at infinity; in step c) the specular part I_{s module,np} of the intensity diffused by the photovoltaic module is obtained by

$${I}_{s module , np} = ( {I}_{2} - {I}_{1} ) \cdot \frac{{F}_{∥ +} {F}_{⊥}}{{F}_{∥ -} {F}_{⊥}}$$

and the specular part I_{s ref,np} diffused by the reference reflector is obtained by means of the relation

$${I}_{s ref , np} = ( {I}_{4} - {I}_{3} ) \cdot \frac{{F}_{∥ +} {F}_{⊥}}{{F}_{∥ -} {F}_{⊥}} with {F}_{∥} = \vert \frac{{n}^{2} cos ( Ψ ) - a}{{n}^{2} cos ( Ψ ) + a} \vert ,$$

Ψ the angle of incidence of the photovoltaic module or on the reference reflector (R), a=\sqrt{n²−sin²(Ψ)} and n is the refractive index of the photovoltaic module (M) or reference reflector (R), I₁ and I₃ being the intensities acquired in the first configuration, I₂ and I₄ being the intensities acquired in the second configuration.

The light source is positioned relative to the photovoltaic module and relative to the reference reflector with an angle of incidence Ψ of the source less than or equal to 15° relative to the normal with the module or reference reflector.
Between step a) and b), the method comprises a1) a step of positioning a reference reflector on the photovoltaic module so as to be illuminated like the photovoltaic module in step a), the reflector being centered on a measuring point located on the photovoltaic module, the light source comprising an optical axis passing through this point.

According to a second aspect, the invention concerns a device for characterizing a photovoltaic module comprising a light source so as to illuminate an object, a spectrometer comprising an optical acquisition axis and a polarizing filter comprising a polarization axis and arranged in front of the spectrometer, the light reflected by the object passing through the polarizing filter to be subsequently captured by the spectrometer, and a processing unit, the device comprising
a first configuration in which the optical axis forms a zero angle with the optical axis of the spectrometer,
a second configuration in which the optical axis is perpendicular to the optical axis of the spectrometer, the second and fourth intensities being acquired in the second configuration, the processing unit being configured to implement steps a), b) c) and d) of the method according to one of the preceding claims.

### DESCRIPTION OF THE FIGURES

Other characteristics, objects and advantages will emerge from the following description, which is purely illustrative and non-limiting, and which must be read with reference to the attached drawings in which:

FIG. 1 illustrates a characterization device illuminating a photovoltaic module according to a first embodiment of the invention;

FIG. 2 illustrates a characterization device illuminating a reference reflector according to the first embodiment of the invention;

FIG. 3 illustrates a characterization device illuminating a photovoltaic module according to a second embodiment of the invention;

FIG. 4 illustrates a characterization device illuminating a reference reflector according to the second embodiment of the invention;

FIG. 5 illustrates a flowchart illustrating a characterization method according to the invention.

FIG. 6 illustrates reflectivity curves obtained by means of the invention;

FIG. 7 schematically illustrates the reflection of a light ray on a medium comprising several interfaces;

FIG. 8 illustrates the effect of a polarizing filter on unpolarized light;

FIG. 9 illustrates the effect of a polarizing filter on polarized light;

FIG. 10 illustrates the effect of roughness on the type of reflection: on the left a rough surface, on the right a smooth surface.

In all the figures, similar elements bear identical references.

### DETAILED DESCRIPTION

### Device for Characterizing a Photovoltaic Module

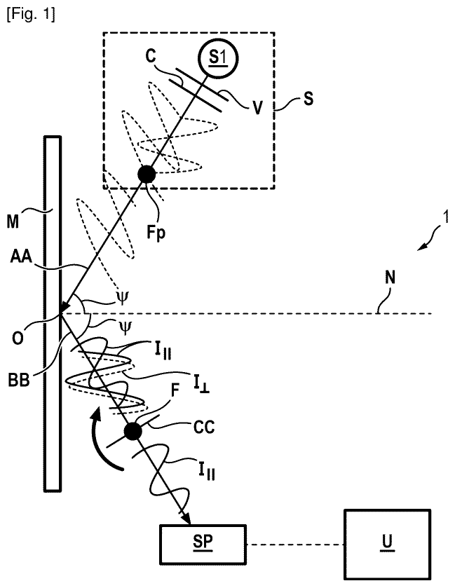

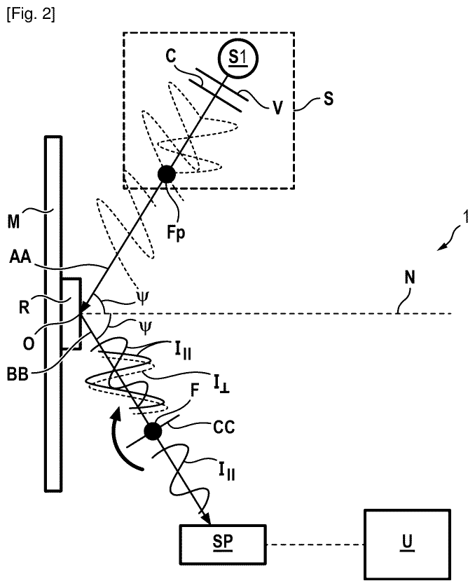

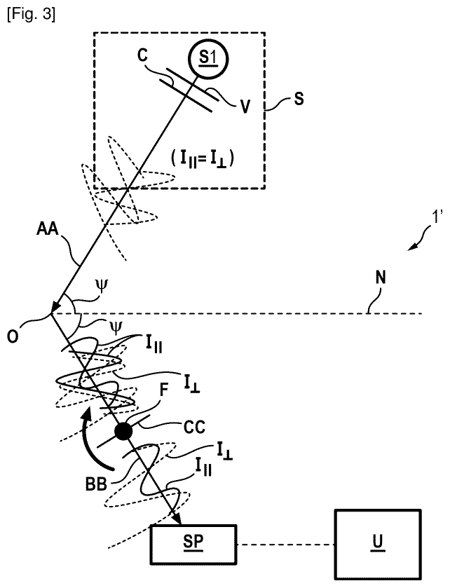

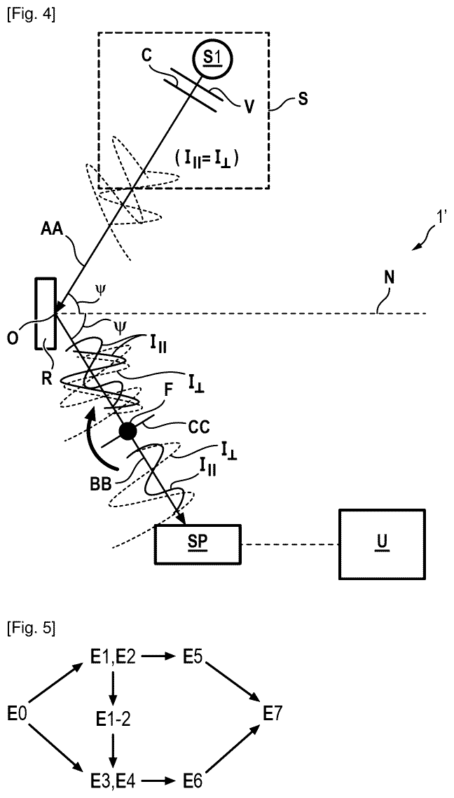

FIG. 1 and FIG. 2 illustrate a device 1 for characterizing a photovoltaic module M according to a first embodiment and FIG. 3 and FIG. 4 illustrate a device 1′ for characterizing a photovoltaic module M according to a second embodiment. The device 1, 1′ comprises, at emission, a light source S comprising an optical axis AA and, at acquisition, a spectrometer SP comprising an optical axis BB and a polarizing filter F comprising a polarization axis CC. The polarizing filter F is circular and allows its polarization axis CC to be placed perpendicular to the optical axis BB of the spectrometer SP or in the optical axis BB of the spectrometer SP.

Preferably, the light source S comprises a non-polarized infinity source S1.

The light source S makes it possible to illuminate in turn a photovoltaic module M and a reference reflector R to carry out various measurements as will be detailed below. To this end, a measuring point O is defined on the module M and the reflector R is centered on this measuring point O. The optical axes AA, BB of the light source S1 and of the spectrometer SP, respectively, pass through this measuring point O.

For example, the S1 infinite source is a halogen lamp with 1000 W and 26,000 lumens of power. A frosted V glass can be placed in front of the source S1 at infinity to make the light more spatially homogeneous. A collimator C is used to collimate the beam and direct it toward the object to be illuminated M, R with an angle normal to the surface of the object M, R. The spectrometer SP is positioned in such a way that the optical axis AA of the source S and the optical axis BB of the spectrometer form angles identical to the normal N to the object M, R to be illuminated. The spectrometer SP is positioned so as to be close to the source S. For example, the spectrometer is a CS-2000 Konica Minolta™ capable of measuring in the visible spectrum from 380 to 780 nm. The measured intensity is given in a known manner in cd/m² which corresponds to the luminance in Lv.

The reference reflector R is a STAN-SSL Specular Reflectance Standard from Ocean Insight™ made from Schott ND9 glass. The reference reflector has a reference spectral reflectivity R_{ref} of 5% between 200 and 950 nm and 4% between 950 and 2500 nm.

A photovoltaic module M is illuminated by the light source S at an angle of incidence Ψ with regard to the normal N along the horizontal, but still parallel to the normal along the vertical. This makes it possible to have only one angle of freedom between the photovoltaic module M and the incident ray in order to simplify and remove potential sources of uncertainty due to the angle. The spectrometer SP is preferably positioned on an adjustable tripod so as to receive the beam at the same angle Ψ. This angle Ψ is at most 15°, a value determined by the inventors below which the diffuse light is not polarized and the measurement uncertainties are less.

According to the first embodiment, the source S is polarized in that it comprises a polarizing filter Fp configured to polarize the source S1 at infinity illuminating the module M or the reflector R. According to the second embodiment, the source S is non-polarized.

The characterization device according to the first or second embodiment is configured for use in a first configuration and in a second configuration.

According to the first configuration, the characterization device 1, 1′ is such that the polarizing filter F in front of the spectrometer SP has its polarization axis CC perpendicular to the optical axis BB of the spectrometer SP, a polarization angle θ between the axis CC and the optical axis BB being equal to 90°.

According to the second configuration, the characterization device 1, 1′ is such that the polarizing filter F in front of the spectrometer SP has its polarization axis CC along the optical axis BB of the spectrometer SP, the polarization angle θ being zero.

A processing unit U controls the acquisition of the intensities measured by the spectrometer and receives them for processing as described below.

### Method for Characterizing a Photovoltaic Module

FIG. 5 illustrates the steps in a method for characterizing a photovoltaic module.

The photovoltaic module is illuminated (step E0) by the source S. The optical axis AA of the source S is oriented toward a measuring point O located on the photovoltaic module M. The measuring point O on the photovoltaic module M is preferably positioned by avoiding screen printing fingers with the help of the tripod adjustment knobs if necessary and the spectrophotometer is focused on the surface of the photovoltaic module M.

In the first configuration with the zero polarization angle θ=0° of the polarizing filter Fp, a first intensity reflected by the module M is acquired (step E1).

In the second configuration with the polarization angle θ=90°, a second intensity reflected by the module M is acquired (step E2).

The transition from the first configuration to the second configuration is effected by rotating the polarizing filter (step E1-2).

The same acquisitions are then carried out but with a reference reflector R which is positioned such that the measuring point O used for the photovoltaic module M is at the same place (steps E3, E4).

A third intensity reflected by the reference reflector R is acquired in the second configuration (step E3) and a fourth intensity is acquired in the first configuration (step E4).

Then using a relation (Equation 14 and Equation 17 below) between the intensities acquired in the two configurations, a specular part of the intensity diffused by the photovoltaic module M is calculated, on the one hand, and a specular part of the intensity diffused by the reference reflector is calculated.

In other words, the calculation is carried out by means of a relationship (Equation 14 and Equation 17 below)
between the first intensity I₁ and the second intensity I₂ of a specular part of the intensity diffused by the photovoltaic module M;
between the third intensity I₃ and the fourth I₄ intensity of a specular part of the intensity diffused by the reference reflector R.

Then, by means of a relationship (Equation 1 below) between the specular part Is_{module} of the intensity diffused by the photovoltaic module (M), the specular part Is_{ref} of the intensity diffused by the reference reflector R, and a reference spectral reflectivity of the reference reflector, a spectral reflectivity R_{ref} (λ) of the photovoltaic module M with λ the wavelength of the intensity acquired by the spectrometer SP is calculated.

The spectral reflectivity R_{module} (λ) of the photovoltaic module M is obtained by the product between the ratio between the specular part of the intensity diffused by the photovoltaic module M and the intensity diffused by the reference reflector R and the spectral reflectivity of the reference reflector R. The following relationship gives the equation of this reflectivity:

$${R}_{module} ( λ ) = \frac{I {s}_{module}}{I {s}_{ref}} {R}_{ref} ( λ ) \qquad ( Equation 1 )$$

In this way, it is possible to evaluate the reflectivity of the anti-reflective coating in order to evaluate its deterioration. This deterioration can be compared, for example, to that of a reference module, not exposed externally, whose reflection will have been measured under the same conditions. It can also be compared to modules without an anti-reflective coating, measured with the same method.

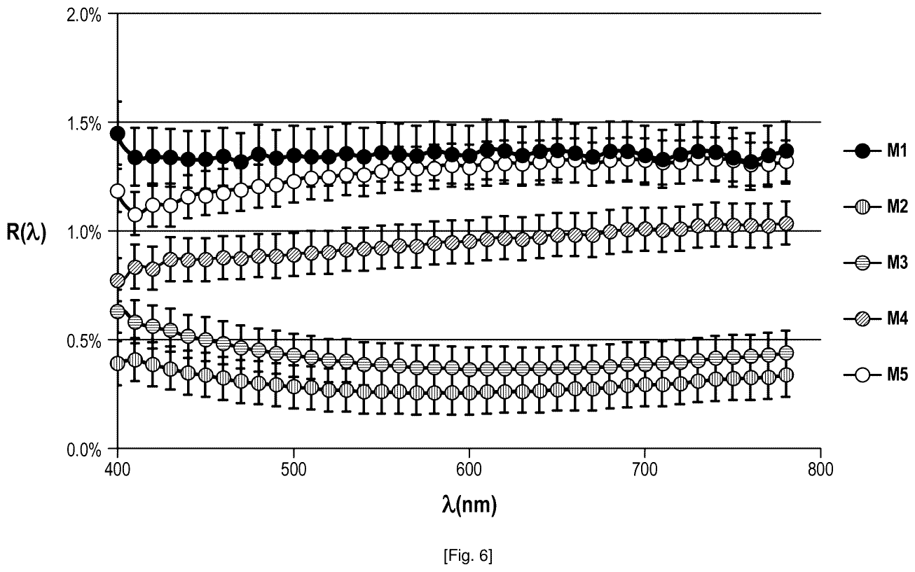

FIG. 6 illustrates such a comparison. In this figure, the spectral reflectivity, i.e., the reflectivity of the modules for each wavelength, here from 400 nm to 780 nm (visible radiation range), of several modules is measured according to the method described here: A reference module without an anti-reflective coating (curve M1), a reference module with an anti-reflective coating (curve M2), a new commercial module (curve M3), a commercial module used in a solar power plant whose anti-reflective coating has been partially degraded (curve M4) and a commercial module with a completely degraded anti-reflective coating (curve M5). The measurements carried out make it possible to demonstrate the degree of degradation of the anti-reflective coatings of the commercial modules with regard to the two reference modules.

Alternatively, it is possible to quantify the overall reflectivity rather than spectral reflectivity by integrating the spectral reflectivity over that of the solar spectrum, the reference of the solar spectrum being generally taken normatively equal to that of the 1.5 G spectrum, defined as the spectral irradiation of the sun on a terrestrial surface, with an orientation and atmospheric conditions specified at 1.5 G according to the normative document Reference Air Mass 1.5 Spectra of the American Society for Testing and Materials (ASTM), a spectrum used when measuring the performance of photovoltaic modules. Thus, weighting spectral measurements with the intensity of the reference solar spectrum makes it possible to quantify the reflection of the global modules between 400 and 780 nm:
M1: 1.3%
M2: 0.3%
M3: 0.4%
M4: 0.9%
M5: 1.2%.

According to a first embodiment, the light source S is polarized by placing a polarizing filter Fp in front of the infinity source S1. FIGS. 1 and 2 respectively illustrate the first and second configurations with the polarized source S. In these figures, dashed lines show the rays arriving from the light source S and reflected with the same angle of incidence. This is specular reflection. Solid lines represent the diffusively reflected rays. The specular light is polarized at the output of the light source S1 by a polarizing filter Fp, so that only the parallel component denoted I_{∥} is reflected. In return, diffused light is not polarized and therefore its two components, denoted parallel and perpendicular, are reflected. The rotating polarizer is placed in front of the spectrometer.

The specular part I_{s module} of the intensity diffused by the photovoltaic module (M) is obtained by I_{s module}=I₂−I₁ and the specular part I_{s ref} diffused by the reference reflector is obtained by means of the relation I_{s ref}=I₄−I₃, I₁ and I₃ being the intensities acquired in the first configuration, I₂ and I₄ being the intensities acquired in the second configuration.

According to a second embodiment, the light source S is non-polarized. FIGS. 3 and 4 respectively illustrate the first and second configuration with the non-polarized source S. In this case, the parallel part is no longer intersected by the fixed polarizer and when θ=90°, we have the incidence of the parallel and perpendicular parts of the diffuse and the specular I_{∥} I_{⊥}, and when θ=0°, the parallel parts I_{∥} of the diffuse and the specular remain.

According to this second embodiment, the specular part I_{s module,np} of the intensity diffused by the photovoltaic module M is obtained

$${I}_{s module , np} = ( {I}_{2} - {I}_{1} ) \cdot \frac{{F}_{∥ +} {F}_{⊥}}{{F}_{∥ -} {F}_{⊥}}$$

and the specular part I_{s ref,np} diffused by the reference reflector is obtained by means of the relationship

$${I}_{s ref , np} = ( {I}_{4} - {I}_{3} ) \cdot \frac{{F}_{∥ +} {F}_{⊥}}{{F}_{∥ -} {F}_{⊥}} with {F}_{∥} = {\vert \frac{{n}^{2} cos ( Ψ ) - a}{{n}^{2} cos ( Ψ ) + a} \vert}^{2} ,$$

Ψ the angle of incidence on the photovoltaic module (M) or on the reference reflector R, a=\sqrt{n²−sin²(Ψ)} and n is the refractive index of the photovoltaic module (M) or the reference reflector, I₁ and I₃ being the intensities acquired in the first configuration, I₂ and I₄ being the intensities acquired in the second configuration.

### Detailed Equations

### A. Reflection, Refraction, Absorption

Incident light on a surface has three possible behaviors: reflection (R), transmission (T) and absorption (A) where R+T+A=1.

For solar modules, the aim is to optimize the transmission of light to PV cells over a given wavelength range. The law of refraction, also known as the Snell-Descartes Law, is presented in equation 3 where n is the index of refraction and Ψ is the angle to the normal for a radius passing through a medium 0 to 1. The limit angle from which the reflection is total R=1, T=0 is given in equation 3 below

$${Ψ}_{L} = asin ( \frac{{n}_{0}}{{n}_{1}} ) \qquad ( Equation 2 )$$

$${n}_{0} {sin Ψ}_{incident} = {n}_{1} {sin Ψ}_{réfléchi} \qquad ( Equation 3 )$$

Here it is possible to measure the reflection directly, T and A being difficult to achieve.

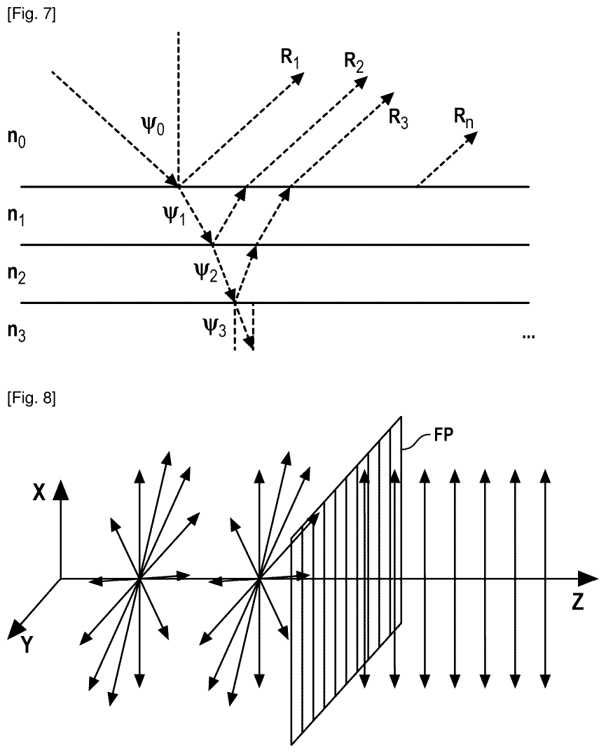

In the case of photovoltaic modules, there is a multi-layer structure as shown in FIG. 7. The measured total reflection of the module is a sum of the reflection of the n layers (R1, R2, R3, . . . , Rn). In this model, intra-layer reflection is neglected due to its small contribution.

The limit angle Ψ_{0L} for obtaining the total reflection of the anti-reflective coating and the glass R1+R2 for an n₁ varying from 1.3 to 1.5 and n₂=1.5 is between 40° and 50°. This means that if we have an angle of incidence Ψ₀≥40° the reflection of the whole module will not be measured. This makes it possible to separate the contribution of the anti-reflective coating.

### B. Fresnel Coefficients

Fresnel coefficients quantify how light is reflected and transmitted at an interface between two media, depending on the angle of incidence and polarization.

Their demonstration is based on the application of Maxwell's equations, which will describe the behavior of the electric and magnetic fields of light. Maxwell equations are applied to each medium, and propagation equations are used to determine incident, reflected, and transmitted electric and magnetic fields.

It is assumed that the solar cell is homogeneous, isotropic and linear. A non-polarized incident light is also considered in a first step.

$${\vec{n}}_{12} ∧ ( {\vec{E}}_{im} + {\vec{E}}_{rm} - {\vec{E}}_{tm} ) = \vec{0} \qquad ( Equation 4 )$$

$${\vec{n}}_{12} \cdot ( {\vec{B}}_{im} + {\vec{B}}_{rm} - {\vec{B}}_{tm} ) = 0 \qquad ( Equation 5 )$$

By applying boundary conditions, we arrive at a linear system which give the reflection coefficients of the parallel component F∥ and the perpendicular component F⊥ because the light becomes slightly polarized after reflection. These equations 6 and 7 are as a function of the angle of incidence Ψi, the angle of refraction Ψt, the refractive index of the media n=n₁/n₀.

$${F}_{‖} ( {Ψ}_{t} , {Ψ}_{i} ) = \frac{tan ( {Ψ}_{t} - {Ψ}_{i} )}{tan ( {Ψ}_{t} + {Ψ}_{i}} \qquad ( Equation 6 )$$

$${F}_{⊥} ( {Ψ}_{t} , {Ψ}_{i} ) = \frac{2 sin ( {Ψ}_{t} ) cos ( {Ψ}_{i} )}{sin ( {Ψ}_{t} + {Ψ}_{i} ) cos ( {Ψ}_{t} - {Ψ}_{i} )} \qquad ( Equation 7 )$$

In a known manner, Fresnel coefficients are normally written taking into account the angle of the refracted ray (Ψₜ) and the incident (Ψᵢ) (see equations 8 and 9). It is a question of eliminating the refracted angle since being in a multi-layer system it is very difficult to measure.

Equivalent expressions are also found for Fresnel coefficients as a function only of n and Ψ, the angle of incidence.

$${F}_{‖} ( n , Ψ ) = \frac{{a}^{2} - 2 a sin ΨtanΨ + {sin}^{2} Ψ {tan}^{2} Ψ}{{a}^{2} + a sin ΨtanΨ + {sin}^{2} Ψ {tan}^{2} Ψ} ; {F}_{⊥} ( η , Ψ ) = {\vert \frac{{n}^{2} cos ( Ψ ) - a}{{n}^{2} cos ( Ψ ) + a} \vert}^{2} \qquad ( Equation 8 )$$

$${F}_{⊥} ( η , Ψ ) = \frac{{a}^{2} - 2 a cos Ψ + {cos}^{2} Ψ}{{a}^{2} + 2 a cos Ψ + {cos}^{2} Ψ} = {\vert \frac{{n}^{2} cos ( Ψ ) - a}{{n}^{2} cos ( Ψ ) + a} \vert}^{2} \qquad ( Equation 9 )$$

$$a = \sqrt{{n}^{2} - {sin}^{2} ( Ψ )} \qquad ( Equation 10 )$$

### C. Polarizers

A polarizer is a device capable of controlling the polarization of light by allowing only the components of the electric field to pass in a given direction. There are several types of polarizers (linear, circular, ellipsoidal), but the simplest and most commonly used is the linear polarizer.

Malus' Law (equation 11) gives the behavior of the perfect polarizer where I is the luminous intensity at the output of the polarizer and I₀ the starting intensity. The angle that this polarization makes with the axis of the polarizer is denoted γ.

$$I = {I}_{0} cos ( γ ) \qquad ( Equation 11 )$$

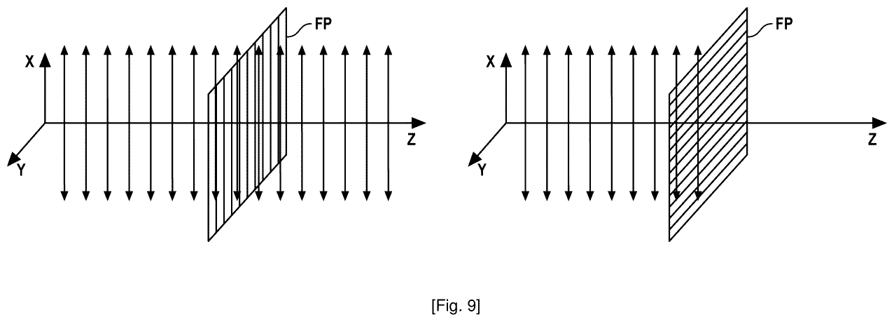

If the light is unpolarized, the linear polarizer will act as an intensity attenuator. According to cos(γ), it will intersect the parallel part and the perpendicular part each equal for the unpolarized light. Half of the original intensity will therefore be attenuated if the polarizer is perfect. FIG. 8 illustrates the effect of a polarizing filter on unpolarized light and FIG. 9 illustrates the effect of a polarizing filter on polarized light.

### D. Specular and Diffuse Light

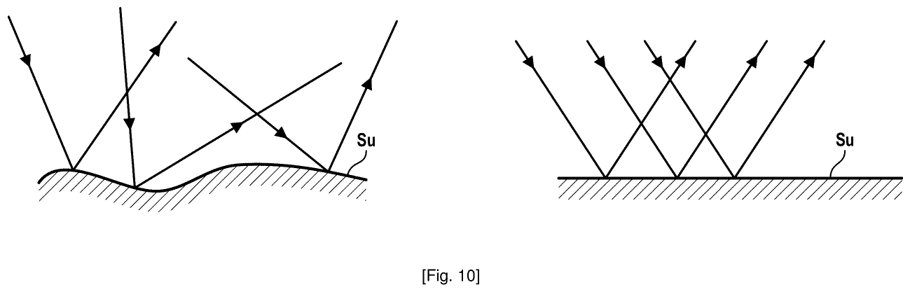

Specular light corresponds to the reflected part with the same angle of incidence, also known as regular and direct reflection. However, if there is roughness on the surface or incident light at angles other than the source, diffuse light will be reflected at angles other than Ψ. FIG. 10 illustrates the effect of roughness on the type of reflection: on the left a rough surface, on the right a smooth surface.

In the invention only the specular part of the light is taken to avoid an overestimation of the reflectance. In addition, polarization eliminates the influence of stray light.

### First Embodiment: Illumination by Polarized Light

As indicated above, specular light is polarized at the output of the light source S1 by a polarizing filter Fp, so that only the parallel component denoted I_{∥} is reflected. In return, diffused light is not polarized and therefore its two components, denoted parallel and perpendicular, are reflected. The rotating polarizer is placed in front of the spectrometer.

Malus' Law gives the perfect polarizer behavior: For the linearly polarized specular wave, the intensity is partly absorbed according to the cos² relationship and for the non-polarized wave the intensity is reduced by half according to equation 12.

$$I ( θ ) = \frac{1}{2} {I}_{d} + {I}_{s} {sin}^{2} ( {I}_{d} ) \qquad ( Equation 12 )$$

When θ=0°, all the rays polarized perpendicularly to the surface of the module are cut and the parallel part of the diffuse remains. This position is called phase opposition and allows the calculation of the diffuse intensity according to equation (13) because the diffuse is not polarized. This measurement is very important because it calibrates the polarization angle. Since the disappearance of the specular beam is quite visible, it is possible to place θ=0° with an accuracy of ±2′. We then have I_{∥} the parallel part of the diffuse.

$${I}_{d} = 2 {I}_{θ = 0 °} = 2 {I}_{‖} \qquad ( Equation 13 )$$

When θ=90°, the perpendicularly polarized part is not cut. Since the diffuse part is already known, the determination of the specular part is given by:

$${I}_{spéculaire} = {I}_{θ = 90 °} - {I}_{θ = 0 °} \qquad ( Equation 14 )$$

### Second Embodiment: Illumination by Unpolarized Light

According to this second embodiment, Fresnel coefficients F_{∥}«F_{⊥} are introduced. They are calculated as a function of the refractive index n and the angle of incidence Ψ defined with regard to the normal of the surface of the module.

Iₛ and Iₐ are the specular and diffuse parts respectively which depend on the measured values.

$$I ( θ ) = \frac{1}{2} {I}_{d} + \frac{{F}_{‖} {cos}^{2} ( θ ) + {F}_{⊥} {sin}^{2} ( θ )}{{F}_{‖} + {F}_{⊥}} {I}_{s} \qquad ( Equation 15 )$$

For the non-polarized (np) case, the specular and diffuse parts can also be separated, but not directly as in the case where the source is polarized (equations 13 and 14). The determination of Iₛ_{ₙₚ} and i_{d}_{ₙₚ} is done by taking equation 16 at θ=90° and θ=0° and subtracting and summing the resulting expressions:

$${I}_{{s}_{n p}} = ( {I}_{θ = 90 °} - {I}_{θ = 0 °} ) \frac{{F}_{‖} + {F}_{⊥}}{{F}_{‖} - {F}_{⊥}} \qquad ( Equation 16 )$$

$${I}_{{d}_{n p}} = {I}_{θ = 0 °} + {I}_{θ = 90 °} - {I}_{{s}_{n p}} \qquad ( Equation 17 )$$

1. A method for characterizing a photovoltaic module, by means of a device for characterizing a photovoltaic module, the characterizing device comprising a light source so as to illuminate an object, a spectrometer comprising an optical acquisition axis and a polarizing filter comprising a polarization axis and arranged in front of the spectrometer, the light reflected by the object passing through the polarizing filter to be subsequently captured by the spectrometer, and a processing unit, the device comprising
a first configuration in which the optical axis of the polarizing filter forms a zero angle with the optical axis of the spectrometer,
a second configuration in which the optical axis of the polarizing filter is perpendicular to the optical axis of the spectrometer,
the method comprising the following steps implemented by the processing unit:
a) acquiring, in the first configuration and in the second configuration respectively, an intensity reflected by a photovoltaic module illuminated by the light source and measured by the spectrometer;
b) acquiring, in the first configuration and in the second configuration respectively, an intensity reflected by a reference reflector and measured by the spectrometer;
c) calculating by means of a relationship between the intensities acquired in each configuration of a specular part of the intensity diffused by the photovoltaic module (M) and a specular part of the intensity diffused by the reference reflector;
d) calculating using a relationship between the specular part of the intensity diffused by the photovoltaic module, the specular part of the intensity diffused by the reference reflector, and a reference spectral reflectivity of the reference reflector of a spectral reflectivity of the photovoltaic module, the spectral reflectivity of the photovoltaic module being characteristic of a wear state of the photovoltaic module.

2. The method as claimed in claim 1, wherein in step d) the spectral reflectivity of the photovoltaic module is obtained by the product between the ratio between the specular part of the intensity diffused by the photovoltaic module and the intensity diffused by the reference reflector and the spectral reflectivity of the reference reflector.

3. The method as claimed in claim 1 wherein the light source comprises a non-polarized main source at infinity and an upstream polarizing filter configured to polarize the main source, the light source illuminating the photovoltaic module and the reference reflector being polarized, in step c) the specular part I_{s module} of the intensity diffused by the photovoltaic module is obtained by I_{s module}=I₂−I₁ and the specular part I_{s ref} diffused by the reference reflector is obtained by means of the relation I_{s ref}=I₄−I₃, I₁ and I₃ being the intensities acquired in the first configuration, I₂ and I₄ being the intensities acquired in the second configuration.

4. The method as claimed in claim 1, wherein the light source comprises a non-polarized main source at infinity; in step c) the specular part I_{s module, np} of the intensity diffused by the photovoltaic module is obtained by
$${I}_{s module , n p} = ( {I}_{2} - {I}_{1} ) \cdot \frac{{F}_{‖ +} {F}_{⊥}}{{F}_{‖ -} {F}_{⊥}}$$
and the specular part I_{s ref,np} diffused by the reference reflector is obtained by means of the relation
$${I}_{s ref , n p} = ( {I}_{4} - {I}_{3} ) \cdot \frac{{F}_{‖ +} {F}_{⊥}}{{F}_{‖ -} {F}_{⊥}}$$
with
$${F}_{‖} = \vert \frac{{n}^{2} cos ( Ψ ) - a}{{n}^{2} cos ( Ψ ) + a} \vert ,$$
Ψ the angle of incidence on the photovoltaic module or on the reference reflector, a=\sqrt{n²−sin²(Ψ)} and n is the refractive index of the photovoltaic module or reference reflector, I₁ and I₃ being the intensities acquired in the first configuration, I₂ and I₄ being the intensities acquired in the second configuration.

5. The method as claimed in claim 1, wherein the light source is positioned relative to the photovoltaic module and relative to the reference reflector with an angle of incidence Ψ of the source less than or equal to 15° relative to the normal with the module or reference reflector.

6. The method as claimed in in claim 1, wherein between step a) and b), the method comprises a1) a step of positioning a reference reflector on the photovoltaic module so as to be illuminated like the photovoltaic module in step a), the reflector being centered on a measuring point located on the photovoltaic module, the light source comprising an optical axis passing through this point.

7. A device for characterizing a photovoltaic module comprising a light source configured to illuminate an object, a spectrometer comprising an optical acquisition axis and a polarizing filter comprising a polarization axis and arranged in front of the spectrometer, the light reflected by the object passing through the polarizing filter to be subsequently captured by the spectrometer, and a processing unit, the device comprising
a first configuration in which the optical axis forms a zero angle with the optical axis of the spectrometer,
a second configuration in which the optical axis is perpendicular to the optical axis of the spectrometer, the second and fourth intensities being acquired in the second configuration, the processing unit being configured to implement steps a), b) c) and d) of the method according to claim 1.

8. The method as claimed in claim 2, wherein the light source comprises a non-polarized main source at infinity and an upstream polarizing filter configured to polarize the main source, the light source illuminating the photovoltaic module and the reference reflector being polarized, in step c) the specular part I_{s module} of the intensity diffused by the photovoltaic module is obtained by I_{s module}=I₂−I₁ and the specular part I_{s ref} diffused by the reference reflector is obtained by means of the relation I_{s ref}=I₄−I₃, I₁ and I₃ being the intensities acquired in the first configuration, I₂ and I₄ being the intensities acquired in the second configuration

9. The method as claimed in claim 2, wherein the light source comprises a non-polarized main source at infinity; in step c) the specular part I_{s module, np} of the intensity diffused by the photovoltaic module is obtained by
$${I}_{s module , n p} = ( {I}_{2} - {I}_{1} ) \cdot \frac{{F}_{‖ +} {F}_{⊥}}{{F}_{‖ -} {F}_{⊥}}$$
and the specular part I_{s ref,np} diffused by the reference reflector is obtained by means of the relation
$${I}_{s ref , n p} = ( {I}_{4} - {I}_{3} ) \cdot \frac{{F}_{‖ +} {F}_{⊥}}{{F}_{‖ -} {F}_{⊥}}$$
with
$${F}_{‖} = \vert \frac{{n}^{2} cos ( Ψ ) - a}{{n}^{2} cos ( Ψ ) + a} \vert ,$$
Ψ the angle of incidence on the photovoltaic module or on the reference reflector, a=\sqrt{n²−sin²(Ψ)} and n is the refractive index of the photovoltaic module or reference reflector, I₁ and I₃ being the intensities acquired in the first configuration, I₂ and I₄ being the intensities acquired in the second configuration.
